(19) United States
(12) Patent Application Publication
(10) Pub. No.: US 2021/0322914 A1
(43) Pub. Date: Oct. 21, 2021

(54) AIR PURIFIER

(71) Applicants: PAUL KEELER, Mundelein, IL (US); JACKSON KEELER, Mundelein, IL (US); SAM KEELER, Barrington, IL (US)

(72) Inventors: PAUL KEELER, Mundelein, IL (US); JACKSON KEELER, Mundelein, IL (US); SAM KEELER, Barrington, IL (US)

(21) Appl. No.: 16/850,038

(22) Filed: Apr. 16, 2020

(51) Int. Cl. B01D 46/00; B01D 35/30

(52) U.S. Cl. CPC B01D 46/0047; B01D 2257/91; B01D 2259/804; B01D 35/30

(57) ABSTRACT

The air purifiers in the present invention can be mounted in a ceiling, positioned on a floor, or completely self-contained. The air purifiers sterilize the air using high-output UV-C energy and a unique multi-chambered internal design to kill viruses, bacteria and allergens is disclosed. The invention is designed to kill airborne pathogens, require no maintenance for 10,000 hours or more, use the highest dosage of 253. nm UV-C light energy of any ceiling-mounted unit, produce the longest exposure time of any ceiling-mounted air sterilizer (>1.0 sec.), use two quite (15 db) fans to control the airflow through the multi-chambered kill zone, operate quietly while positioned in the ceiling or on the floor, and designed to be inexpensive to manufacture.

### FIELD OF THE INVENTION

The present invention is related to air purifiers and more particularly to an electric-operated, commercial-grade, self-contained device for sanitizing indoor air within one dedicated room or area.

### BACKGROUND OF THE INVENTION

Wherever people are forced to breathe the same indoor air, the risk of contracting and airborne disease is increased. This is especially a problem in elevators, waiting rooms, reception areas—as well as at home where he sick person is very likely to infect a family member due to the spread of airborne pathogens. Elderly persons and those with reduced immunity protection are particularly at risk of getting sick from exposure to airborne viruses, bacteria, mold spores and allergens.

Many people seek to create a “safe space” around their desk at work or in the bedroom at home with an air purifier—but the majority of air purifiers are little more than fans with filters attached, and if the filter is not properly maintained and changed it right regular intervals the air purifier can actually be a source for airborne contamination of disease.

One of the most effective ways to eradicate airborne pathogens is with the use of UV-C light energy which is been used in hospital operating rooms for many years, but these devices are large, fragile, expensive and potentially dangerous to operate with any persons who may remain in the same room and risk being exposed to the UV-C light energy.

The present invention is different as it effectively eradicates airborne pathogens with a powerful dose of UV-C light energy which is safely contained within internal chambers. The present invention uses air sterilizers that are highly effective and utilize a powerful dose of UVC light energy but is also safe to be operated while persons in the same room going about their daily activities. The present invention creates a dome of healthy sterilized air—free from airborne pathogens and allergens.

### SUMMARY OF THE INVETION

The present invention is directed to air purifiers. The present invention is not particularly directed to a filter, rather, it is an air sterilizer designed to kill airborne pathogens (not just trap in a filter). There is no maintenance required, since there are no filters to change; it can sterilize for approximately 10,000 hours or more of operation before requiring any maintenance. The present invention uses the highest dosage of UV-C energy (253.7 nm) to sterilize the air.

The invention provides the longest exposure time of any compact air purifier (24″×24″_air sterilizer) with the ability to provide >1.0 seconds of continuous UV-C exposure. The invention is designed with a unique internal multi-chambered design that forces the captured air back and forth within the clear chambers in close proximity to multiple UV-C lamps in order to provide >1.0 seconds of continuous UV-C exposure at 253.7 nm. Irradiation Dosage=Intensity of UV-C Radiation×Exposure Time. The invention uses at least two quite 15 db fans to control the airflow through the multi-chambered zone—one fan vacuums the room air while the other recycles the clean air back into the room.

In various embodiments, invention is designed to operate quietly while positioned in a standard ceiling grid within a public space (waiting room, office, classroom, nursing home, day-care facility, etc.); or operate as a stand alone floor model; or as a self-contained mobile unit; all of which operate while occupants go about their regular daily activities unaware that the invention is sterilizing the air. The invention is designed to be relatively inexpensive to manufacture so that it can be used in more facilities and help protect more people than is the case with more expensive sterilizers.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of an air purifying unit for installing onto or into a surface in accordance with one embodiment of the invention;

FIG. 2 is a perspective internal view of an air purifying unit in accordance with one embodiment of the invention;

FIG. 3 is an exploded view an air purifying unit in accordance with one embodiment of the invention;

FIG. 4 is perspective view of an air purifying unit in accordance with one embodiment of the invention;

FIG. 5 is a top plan view of an air purifying unit showing air flow movement in accordance with one embodiment of the invention;

FIG. 6 is a side view of an air purifying unit showing air flow movement in accordance with one embodiment of the invention;

FIG. 7 is a side view of an air purifying unit showing air flow movement in accordance with one embodiment of the invention;

FIG. 8 is a perspective view of an air purifying unit for installing onto or into a surface in accordance with another embodiment of the invention;

FIG. 9 is an exploded view of an air purifying unit for installing onto or into a surface in accordance with one embodiment of the invention;

FIG. 10 is an exploded view of an air purifying unit for installing onto or into a surface in accordance with one embodiment of the invention;

FIG. 11 is an exploded view of an air purifying unit for installing onto or into a surface in accordance with one embodiment of the invention;

FIG. 12 is a perspective view of an air purifying unit for placement on a surface in accordance with one embodiment of the invention;

FIG. 13 an exploded view of an air purifying unit for placement on a surface in accordance with one embodiment of the invention;

FIG. 14 is a perspective view of an air purifying portable unit in accordance with one embodiment of the invention;

FIG. 15 is a bottom view of an air purifying portable unit in accordance with one embodiment of the invention; and

FIG. 15 is a bottom view of an air purifying portable unit in accordance with one embodiment of the invention.

### DETAILED DESCRIPTION OF THE DRAWINGS

While the invention is susceptible to embodiments in many different forms, there are shown in the drawings and will be described in detail herein the preferred embodiments of the present invention. It should be understood, however, that the present disclosure is to be considered an exemplification of the principles of the invention and is not intended to limit the spirit or scope of the invention and/or claims of the embodiments illustrated.

As stated above, most high-output UV-C sterilizers require all occupants to leave the room (such as in an operating room) while the sterilizer is working, otherwise its invisible UV-C light energy could severely damage human skin and eyesight. Other units are attached to the building or house's main ventilation system requiring professionals to install and maintain. The present invention solves these problems. The air sterilizer is able to kill airborne viruses, bacteria and allergens with a high dose of UV-C energy while occupants remain in the room—unaware that the device is working. The claimed invention differs from what currently exists. The present invention has many advantages over any other air purifier on the market: (a) first, the invention is not a filter, it kills rather than trapping or attempting to trap airborne pathogens; (b) there is no maintenance required for 10,000 hours of operation or more; (c) the invention uses the highest dosage of 253. nm UV-C energy of any 24″×24″ unit in the world; (d) the invention has a unique internal design with multi-chambered design with clear acrylic side-walls that forces the air back and forth in direct or close proximity to multiple UV-C lamps; (e) the invention uses at least two quite (15 db) fans to control the airflow through the multi-chambered kill zone; (f) the invention is designed to operate quietly while positioned in a room with occupants being unaware that the invention is sterilizing the air and protecting occupants; (g) the invention is designed to be inexpensive to manufacture so that more schools, businesses, government agencies and non-profits can afford to buy and install as many units as appropriate for their facilities.

The invention has many advantages over any other units on the market: (a) other units require occupants to leave the room while the unit works (not practical for 24/7 or all day long operation); (b) other units are primarily filters with a single UV-C lamp added; (b) most “upper room” UV-C sterilizers shoot out UV-C energy into the room which could temporarily blind occupants; and (c) most large hospital-grade UV-C sterilizers are large, expensive, fragile and awkward to use.

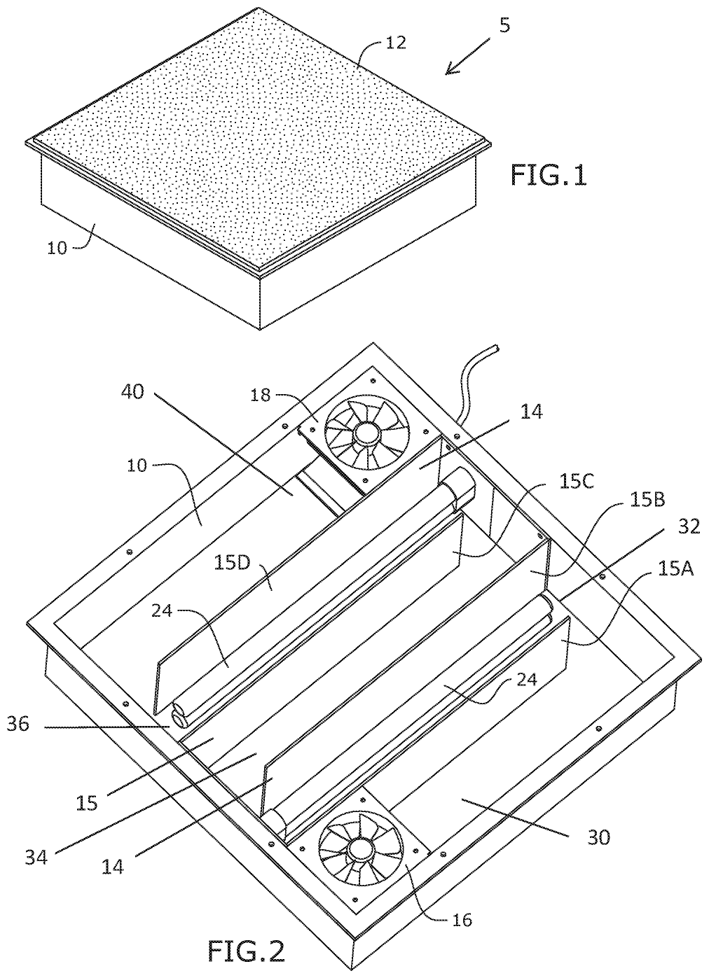

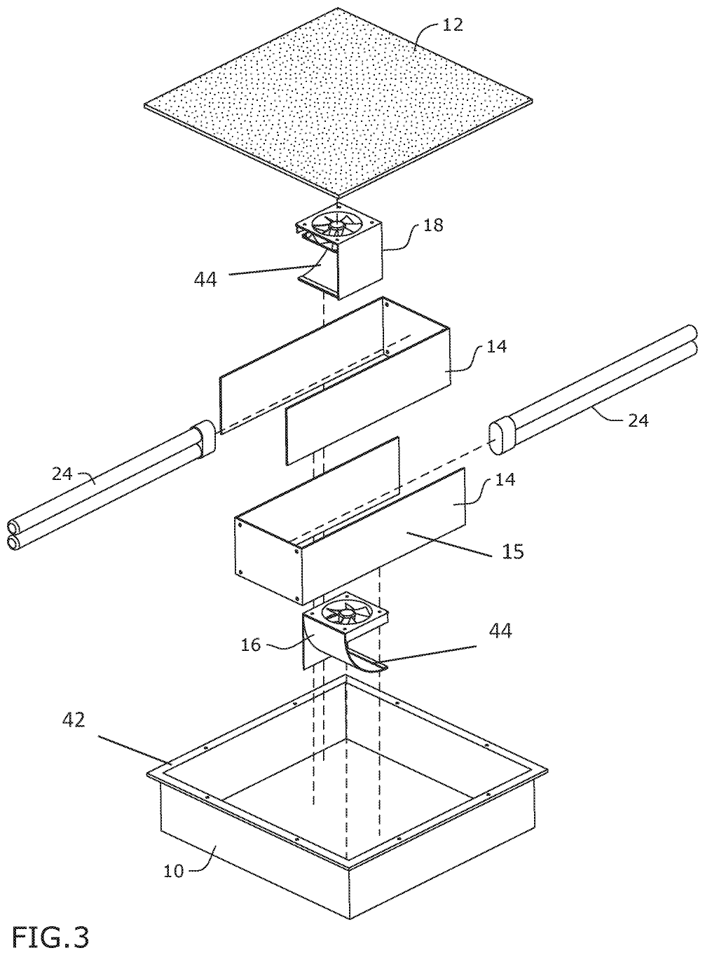

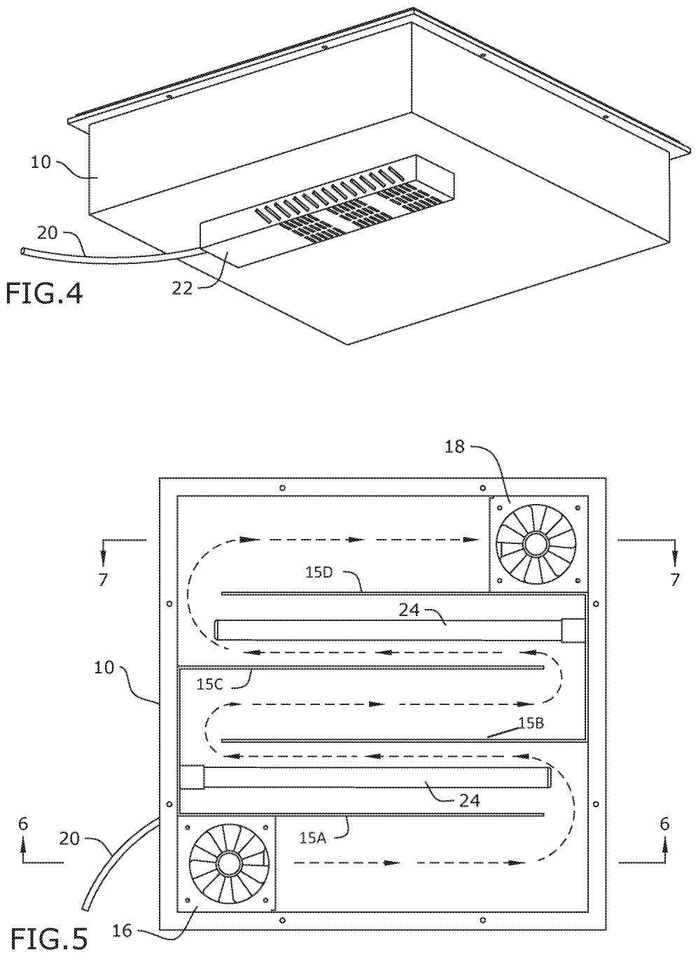

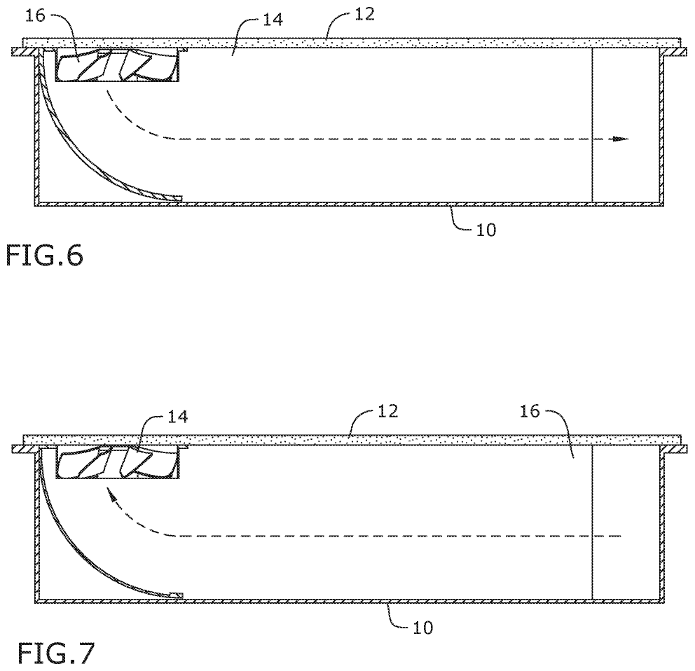

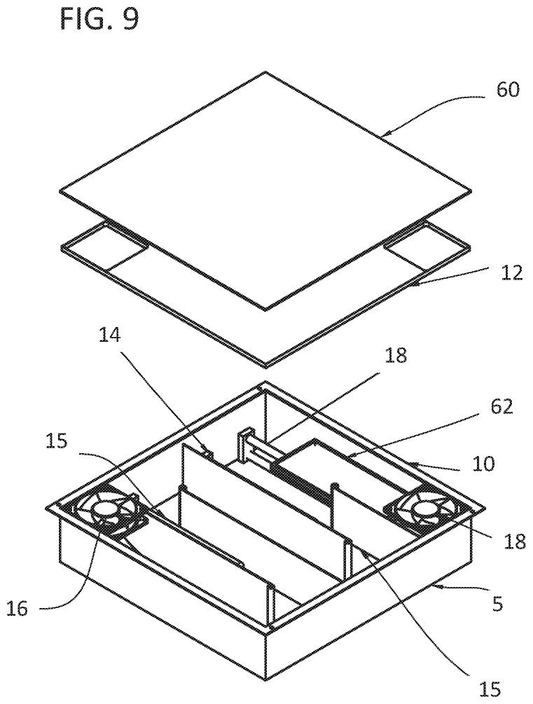

Referring now to FIGS. 1-9, there is shown in a first embodiment of the invention a ceiling air purifier 5. The ceiling air purifier can be installed in replace of a ceiling tile or into the ceiling drywall. The ceiling air purifier 5 includes an outer frame 10 to hold the components and includes an exterior filter 12 that covers the top opening 13 of the frame. The frame is divided into sections by internal baffles 14. In the first embodiment there are two baffles that have walls 15 with openings and exists staggered in relation to each other to cause the air flowing through the frame to slow down as it travels around each baffle. Around each of the walls 15, the frame could be considered to have five channels as discussed below. Air is pushed and pulled through the frame by an entrance push fan 16 that draws are from the outside and pushes it into an entrance channel 30. A second fan 18 is provided to pull air (now purified) from the exit channel 40 and push it to the outside. Situated within the channels are two UV-C bulbs or lamps 24.

As air enters the frame into the entrance channel 30, the air continues to flow around the first wall 15A to enter the second channel 32 defined between the first wall 15A and the second wall 15B. Positioned in the second channel 32 is a UV-C lamp 24. Air will continue through the second channel 32 around the second wall 15B and into the third channel 34 (between the second wall 15B and third wall 15C). The air continues to travel around the third wall 15C and into the fourth channel 36. Positioned in the fourth channel 36 is a UV-C lamp 24. Air moves through the fourth channel 36 around the fourth wall 15D to enter into the exit channel 40, where the air is forced out by the second fan 18.

The frame 10 of the ceiling air purifier 5 may further include a flange 42 used to secure the frame to the ceiling. The frame may also incorporate curved air deflectors 44 about each fan to move the air in the proper direction.

The ceiling air purifier 5 may use the following components: (1) 74 CFM 120 mm fan sucks air into the unit in a continuous fashion; (2) 36-watt 253.7 nm UV-C lamps with quartz sleeves to maximize UV-C energy transmission, unique scoop-design air defectors for air entering and exiting the device, an internal baffling system that squeezes approximately 110 lineal inches (over 1,700 cubic inches)—with the walls of the internal chambers made with cell-cast acrylic that was engineered for maximum UV-C transmission; a second 74 CFM fan assists in maintaining a controlled airflow velocity through the internal chambers and exhausting clean air back into the room.

In addition, the following steps are not related to the previous steps outlined in this application. A unit can be positioned at one end of a room (multiple units recommended for larger rooms). Fan A (Entrance fan) stirs static room air by sucking it to the unit while Fan B (exit fan) pushes and continues to stir the air within the room. The two fans are designed to work in orchestration to pull room air into the unit internally baffled clear chambers where (2) 36-watt UV-C lamps generate a high dosage of 253.7 nm anti-germicidal energy. The (5) internal chambers within the unit force the incoming air to be continuously exposed to the UV-C energy while traveling back and forth within the unit.

The purifier contains an internal baffling system that slows down the fast-moving air and causes every cubic inch to be continuously exposed to a relatively high dosage of UV-C light energy generated from the two UV-C lamps. These UV-C lamps are strategically positioned in chambers #2 and #4—creating interlocking lines of irradiation in all five chambers. With the clear cell-cast acrylic walls between each of the chambers, even the chambers with no UV-C lamp positioned within it (that is, chambers #1, #3 and #5), the UV-C energy transmission is designed to be greater than any competitive. 24″×24″ air sterilizer with a single UV-C lamps (typically 18-watts). The unit provides 72 watts of UV-C (400% of any competitor of the same size) and for a duration 500% as long as any single-pass airflow design. The unit pushes and pulls the internal airflow in order to maintain even and predicable airflow. With is 72 CFM fans, the unit can exchange the air 4-times per hour with a typical 900 CF room (or 2-times per hour with a larger 1,800 CF room). Larger rooms or those with a clearance higher than 9′ should use multiple air sterilizer units.

A ballast box 22 sits outside of the 24″×24″×4″ high sterilizer—this ballast box contains a UL-approved knock-out for a 110-120 VAC electrical whip to bring electrical service to the unit. Within the ballast box is a fluorescent ballast capable of driving the (2) 36-watt, T5, 4-pin UV-C lamps. Also located in the box is a step-down transformer that delivers 12 VDC power to the (2) fans that consume a combined 0.35 amps. The ballast box is positioned on back of the sterilizer unit when properly installed within a 2-foot×2-foot ceiling grid system.

The internal chamber with its multiple internal chambers is the preferred method of the unit—it is what allows the unit to continuously bring in and exhaust air through the unit with providing an extended period of time (greater than a straight air-flow design) with a predictable airflow velocity and therefore provide a long duration of UV-C exposure (longer exposure and more intensive than any other 24″×24″ air sterilizer available today.

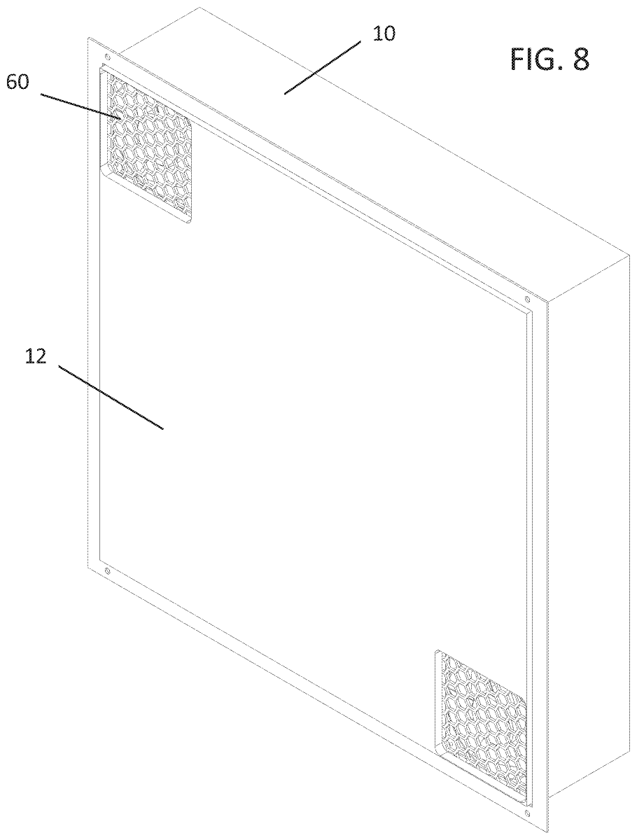

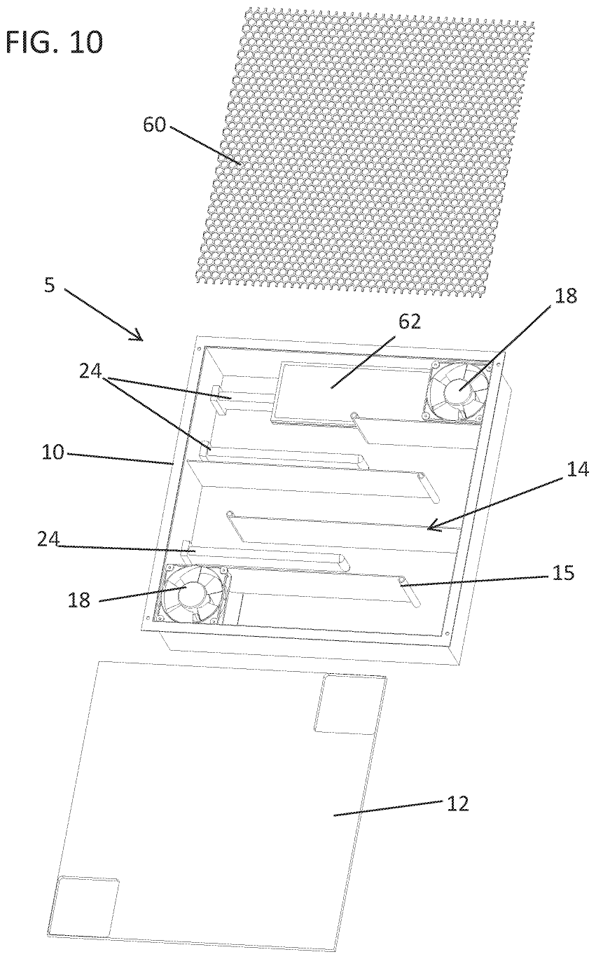

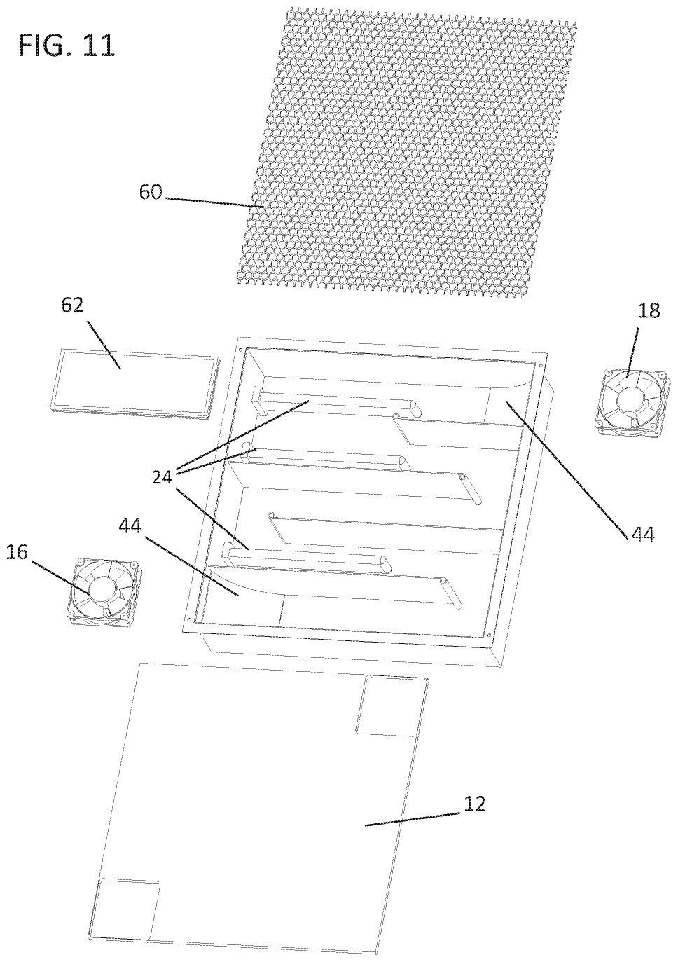

In another embodiment of the invention, illustrated in FIGS. 8-11, there is provided a ceiling air unit 5 similarly constructed, except having a mesh face 60 positioned between the frame 10 and the cover 12, which may be a foam seal of a low-density polyethylene. In this embodiment, the invention may include a filter 62 positioned in the exit channel by the exit fan, such that the purified air travel through a filter 62 right before the air exists. In addition, a third UV-C lamp 24 can be positioned in the 4^{th} channel prior to the exit channel.

The filter 62 may be a Photocatalytic Oxidation (PCO) filter, which is a very powerful air purification technology and can destroy particles as small as 0.001 microns (nanometer)

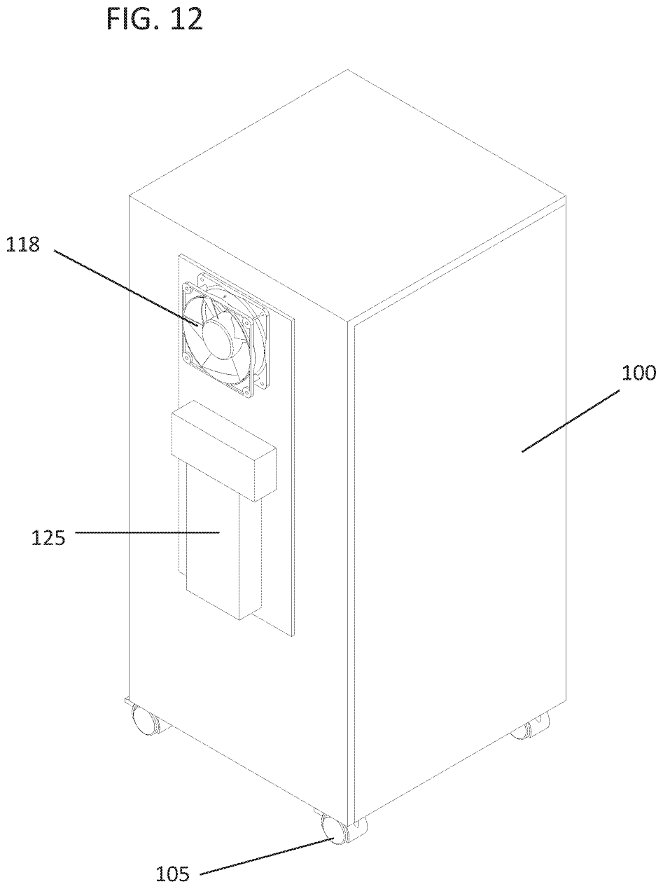

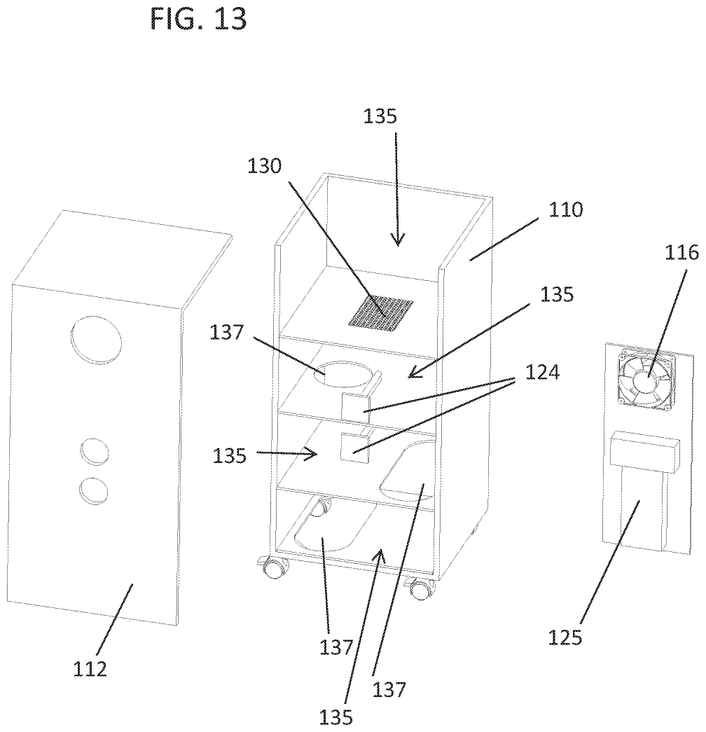

In another embodiment of the invention, illustrated in FIGS. 12-13, there is provided a floor air purifier unit 100 similarly constructed in that it includes channels for the air to travel through, at least one exit fan 118 to pull air through the chamber and blow the purified air out, and UV-C lamps 124 positioned in two or more of the channels. The floor unit 100 also includes wheels 105 on the bottom such that the floor unit can be easily placed in a room. As opposed to installing a ceiling unit, the floor unit 100 includes a power supply 125 used to plug into a typical wall electrical plug. The floor unit 100 includes a housing 110 with a cover 112. Air travels through a filter 130 before reaching the exit fan 116. Chamber 135 are stacked and with openings 137 on opposite sides to slow the air movement through the system to ensure air is properly exposed to the UV-C lamps.

The floor unit represent the development of a system whereby the units would be positioned in a room or tent or other enclosed space of 1,000-5,000 cubic feet ideally. The floor unit can be placed near one corner with its exhaust pointing out and slowly stirring the air in a clock-wise motion. The air inlet 116 would be low and along the floor—the exit fan 118 would be higher and sending the air out in the clockwise motion.

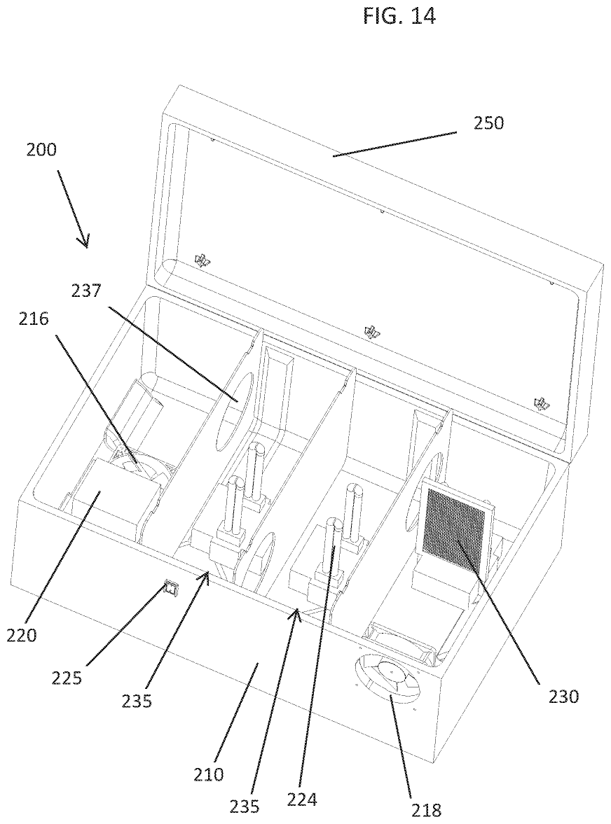

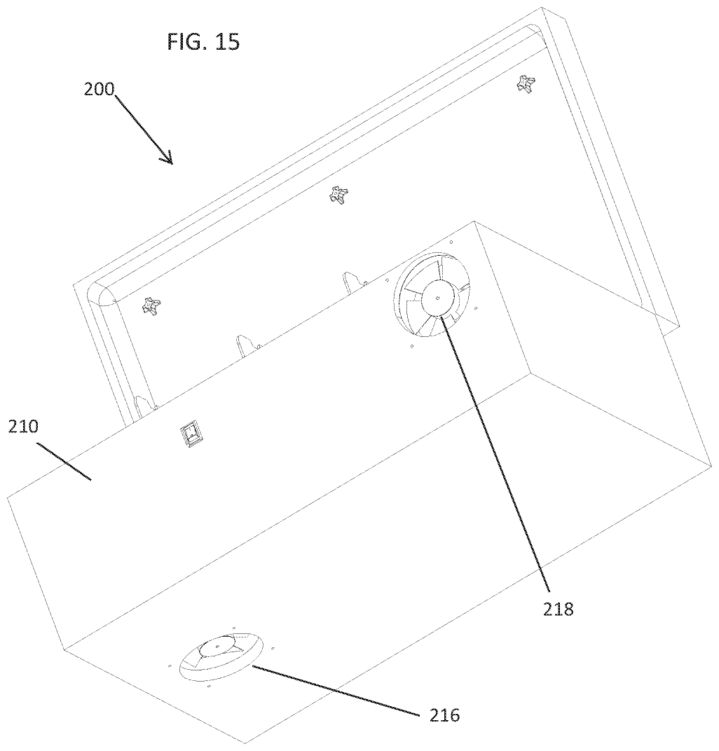

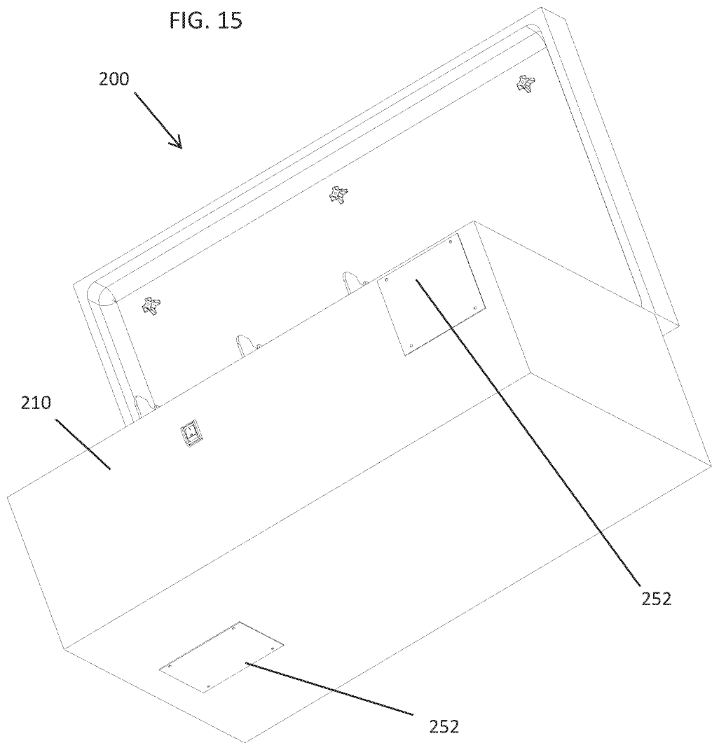

Similarly, in FIGS. 14-16, a completely self-contained portable unit 200 would have a rechargeable battery pack 220 to run the unit, along with an on/off switch 225 to activate and deactivate the unit. This would allow the system to be used in outdoor tents or where the unit could not be plugged in to draw power. In a portable unit 200, there would be provided a case or housing unit 210, with UV-C lamps 224 positioned within chambers 235 with chamber openings 237 that allow air from an intake fan 216 to travel to an exit fan 218. A filter 230 can be provided by the exit fan 218. Legs or wheels could be provided on the bottom to keep the unit off the fall and to ensure the intake fan remains unobstructed. While illustrated in an open configuration, the lid 250 would most likely be sealed in a closed configuration to avoid the user turning on the machines and expose themselves to the UV-C lamps. Lastly, a mesh cover 252 could be used over the fan intakes to keep large particulates out of the system.

In addition, in the opposite corner of the room is one can position Negative Ion Generator that produces trillions of (−) ions. This ionic action will cancel out the (+) charge on airborne dust, allergens and pathogens—once they lose their ability to be lighter than air, the particles will fall to the floor. Air currents will eventually sweep this heavy dust over near the floor unit where it will be sucked in the unit and neutralized by the UVC and PCO actions of the unit. In this system, an optional small fan anywhere in the room will continue to assist and speed up the action. The final option in this system is an open water feature or a shower, or humidifier. This increase in available humidity increases the performance of the PCO within the floor unit. High humidity “turbo-charges” the production of Hydroxyl Radicals.

From the foregoing and as mentioned above, it is observed that numerous variations and modifications may be effected without departing from the spirit and scope of the novel concept of the invention. It is to be understood that no limitation with respect to the embodiments illustrated herein is intended or should be inferred. It is intended to cover, by the appended claims, all such modifications within the scope of the appended claims.

We claim:

1. An air purifying unit comprising:
a housing frame configured to have a base and a continuous outer wall to create a cavity therebetween, the continuous outer wall having an upper edge to define an upper periphery rim around the cavity;
an entrance inlet having an entrance fan to draw air into the housing frame and push air through the housing frame;
an exit outlet having an exit fan to pull air through the housing frame and push air out of the housing frame;
a plurality of internal walls extending from an internal surface of the continuous outer wall inwardly to create a plurality of connected channels extending from the entrance inlet to the exit outlet, wherein the plurality of connected channels are configured in a parallel configuration and further configured as a first channel, last channel and at least one intermediate channel, and wherein the first channel has a first entrance connected to the entrance inlet and the last channel has a last exit connected to the exit outlet, and wherein the at least one intermediate channel has an intermediate entrance connected to a first exit of the first channel and an intermediate exit connected to a last entrance of the last channel, the plurality of connected channels further defining walls between the channels such that an air flow must travel through each channel from the entrance inlet to the exit outlet;
a pair of UV-C lamps separately positioned in two channels of the plurality of connected channels;
a top lid positioned over the cavity and having a pair of openings configured to align with the entrance and exit fans; and
a flange extending from the upper periphery rim of the housing frame to secure the air purifying unit to a surface.

2. The air purifying unit of claim 1, wherein the plurality of connected channels is defined as five channels, configured as the entrance channel, exit channel, and at least three intermediate channels.

3. The air purifying unit of claim 2, wherein the three intermediate channels define a second, third, and fourth intermediate channels and the pair of UV-C lamps are separately positioned in the second intermediate channel and the fourth intermediate channel defined from the at least three intermediate channels.

4. The air purifying unit of claim 1, wherein the entrance inlet and exit outlet each include curved air deflectors.

5. The air purifying unit of claim 3, wherein each of the channels includes walls made from a material configured to allow the transmission of UV-C light through the walls such that the air within the housing frame is continuously exposed to UV-C light.

6. The air purifying unit of claim 5, wherein the base and the continuous outer wall is made from a material configured to minimize the transmission of UV-C light therethrough.

7. The air purifying unit of claim 1 further comprising a mesh face positioned under the top lid.

8. The air purifying unit of claim 7 further comprising an air filter in the exit channel adjacent the exit fan, such that air must travel through the air filter before exiting the exit outlet.

9. The air purifying unit of claim 8 further comprising a third UV-C lamp being positioned in an intermediate channel adjacent to the exit channel.

10. An air purifying unit comprising:
a housing frame configured to have a base and a continuous outer wall to create a cavity therebetween, the continuous outer wall having an upper edge to define an upper periphery rim around the cavity;
an entrance inlet having an entrance fan to draw air into the housing frame and push air through the housing frame;
an exit outlet having an exit fan to pull air through the housing frame and push air out of the housing frame;
a plurality of baffles positioned within the housing frame and extending from the entrance inlet to the exit outlet to create an alternating plurality of connected channels configured in a parallel connected configuration wherein an entrance of an intermediate connected channel is in communication with an exit of a preceding connected channel and an exit of an intermediate connected channel is in communication with an entrance of a subsequent connected channel and wherein a first channel has a first entrance connected to the entrance inlet and a last channel has a last exit connected to the exit outlet, the plurality of baffles further defining walls between the channels such that an air flow must travel through each channel from the entrance inlet to the exit outlet;
a pair of UV-C lamps separately positioned in two channels of the plurality of connected channels;
a top lid positioned over the cavity and having a pair of openings configured to align with the entrance and exit fans;
a mesh face positioned under the top lid; and
wherein walls of the baffles are made from a material configured to allow the transmission of UV-C light through the walls such that the air within the housing frame is continuously exposed to UV-C light, and wherein the base and the continuous outer wall are made from a material configured to minimize the transmission of UV-C light therethrough.

11. The air purifying unit of claim 10, wherein the plurality of connected channels is defined as five channels, configured as the entrance channel, exit channel, and at least three intermediate channels, and wherein the three intermediate channels define a second, third, and fourth intermediate channels and the pair of UV-C lamps are separately positioned in the second intermediate channel and the fourth intermediate channel defined from the at least three intermediate channels.

12. The air purifying unit of claim 11, wherein the entrance inlet and exit outlet each include curved air deflectors.

13. The air purifying unit of claim 10 further comprising a flange extending from the upper periphery rim of the housing frame to secure the air purifying unit to a surface.

14. The air purifying unit of claim 10 further comprising an air filter in the exit channel adjacent the exit fan, such that air must travel through the air filter before exiting the exit outlet.

15. The air purifying unit of claim 14 further comprising a third UV-C lamp being positioned in an intermediate channel adjacent to the exit channel.

16. An air purifying unit comprising:
a housing frame configured to have a base and a continuous outer wall to create a cavity therebetween;
an entrance inlet in the base;
an exit outlet having an exit fan to pull air through the housing frame and push air out of the housing frame;
a plurality of shelves positioned within the housing frame, each shelf having an opening to create internal connected baffles and wherein the openings of each internal baffle is positioned distal to a preceding opening and subsequent opening such that an air flow must travel along each internal baffle from the entrance inlet to the exit outlet;
a pair of UV-C lamps separately positioned in two of the shelves of the plurality of connected internal baffles; and
an air filter adjacent the exit fan, such that air must travel through the air filter before exiting the exit outlet.

17. The air purifying unit of claim 16, wherein walls of the baffles are made from a material configured to allow the transmission of UV-C light through the walls such that the air within the housing frame is continuously exposed to UV-C light, and wherein the base and the continuous outer wall are made from a material configured to minimize the transmission of UV-C light therethrough.

18. The air purifying unit of claim 16 further comprising a plurality of wheels connected to the base and configured for movement along a surface.

19. The air purifying unit of claim 17 further comprising an entrance fan to draw air into the housing frame and push air through the housing frame.

20. The air purifying unit of claim 19 further comprising a rechargeable power supply to operate the air purifying unit.
